(19) United States
(12) Patent Application Publication
(10) Pub. No.: US 2009/0063996 A1
(43) Pub. Date: Mar. 5, 2009

(54) METHODOLOGY AND PROCESS FOR SUPPRESSING DE-FOCUSING ACTIVITIES DURING SELECTIVE SCHEDULED MEETINGS

(75) Inventors: Morten K. Kristiansen, Ratoath (IE); Carol S. Zimmet, Boxborough, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,791

(22) Filed: Aug. 29, 2007

(51) Int. Cl. G06F 3/00

(52) U.S. Cl. 715/758

(57) ABSTRACT

Within exemplary embodiments of the present invention repeating calendar event scheduling application options are implemented to support the implementation of a distraction-free meeting event. This aspect is accomplished by the calendar event invitation specifically stating that the meeting is expected to be distraction free, and as such, the acceptance of a meeting invitation would require that the meeting invitee submit to the computing system suspension requirements that are necessitated to initiate a distraction-free meeting. This meeting policy is enforced by the calendar event scheduling application being configured to effectively suspend the local activity of a computing system or incoming and outgoing communication requests that are received at the computing system.

### BACKGROUND OF THE INVENTION

1. Field of the Invention

This invention relates to the field of calendar event scheduling, and particularly to the field of the suppression of computing system activities initiated by a calendar event.

2. Description of Background

Typically, the handling these multiple input sources or requests of our time is a manageable activity during many times in the day. However, there are times during the day or during a period of time when it is necessary to turn off or suppress incoming communications or distractions that our local systems provide. This is often due to a planned event that includes two or more individuals. Distractions to an event, which need to be prevented at times, can also be in the form of an individual opening a new application or reading an email on a local system. The challenge is that since there are so many interruptions and demand in an individual's day it is hard to focus and allocate dedicated time. Thus either or both the attending individual or the initiator may want to be able to block out the incoming or outgoing distractions in order to focus on the content that is offered in that scheduled period.

### SUMMARY OF THE INVENTION

The shortcomings of the prior art are overcome and additional advantages are provided through the provision of a method for the suppressing computing system activities during a scheduled event. The method comprises creating an invitation for an event at an event scheduling application executing at a primary computing system, the event invitation comprising an exclusive attendance event acceptance category and a non-exclusive attendance event acceptance category, transmitting the event invitation from the event scheduling application executing at the primary computing system to at least one secondary computing system, and receiving the event invitation at an event scheduling application that is executing at the secondary computing system.

The method further comprises accepting the event invitation at the event scheduling application executing at the secondary computing system, where in the instance that the event is accepted as an exclusive attendance event then communication and non-event scheduling application executing activities within the secondary computing system will be suspended upon the initiation of the event, and in the instance that the event is accepted as a non-exclusive attendance event a message is generated and delivered to the primary event scheduling application reporting that the event has been accepted as a non-exclusive event, and generating an event reminder at the event scheduling application executing at the secondary computing system.

The method yet further comprises initiating the event, wherein upon the initiation of the event the communication and non-event scheduling application executing activities within the secondary computing system are suspended, displaying a GUI window at the secondary computing system at the initiation of the event, where in the instance that the event is accepted as an exclusive attendance event then the operator of the secondary computing system is presented with the option of disabling the system suspension of the secondary computing system and exiting the event, and restoring the communication and non-event scheduling application executing activities within the secondary computing system upon the completion of the event.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is a screen shot of a meeting invitation with expressly showing that the meeting invite is in regard to an exclusive meeting event.

FIG. 1B is a screenshot of a GUI comprising selection boxes for the configuration of an exclusive and non-exclusive meeting attendance acceptance event.

FIG. 2 is a screenshot of A GUI showing the current meeting event attendance status of a meeting invitee.

The detailed description explains the preferred embodiments of the invention, together with advantages and features, by tray of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention relate to concept that for particular scheduled meetings the initiator of the meeting may desire that the meeting attendees not be distracted by outside computational system distractions. A typical meeting could range in time from a scheduled minimum meeting time up to the scheduled maximum meeting time. Repeating calendar event scheduling application options are implemented to support the implementation of a distraction free meeting event. This aspect is accomplished by the calendar event invitation specifically stating that the meeting is expected to be distraction free, and as such, the acceptance of a meeting invitation would require that the meeting invitee submit to the computing system suspension requirements that are necessitated to initiate a distraction-free meeting. This meeting policy is enforced by the calendar event scheduling application being configured to effectively suspend the local activity of a computing system or incoming and outgoing communication requests that are received at the computing system.

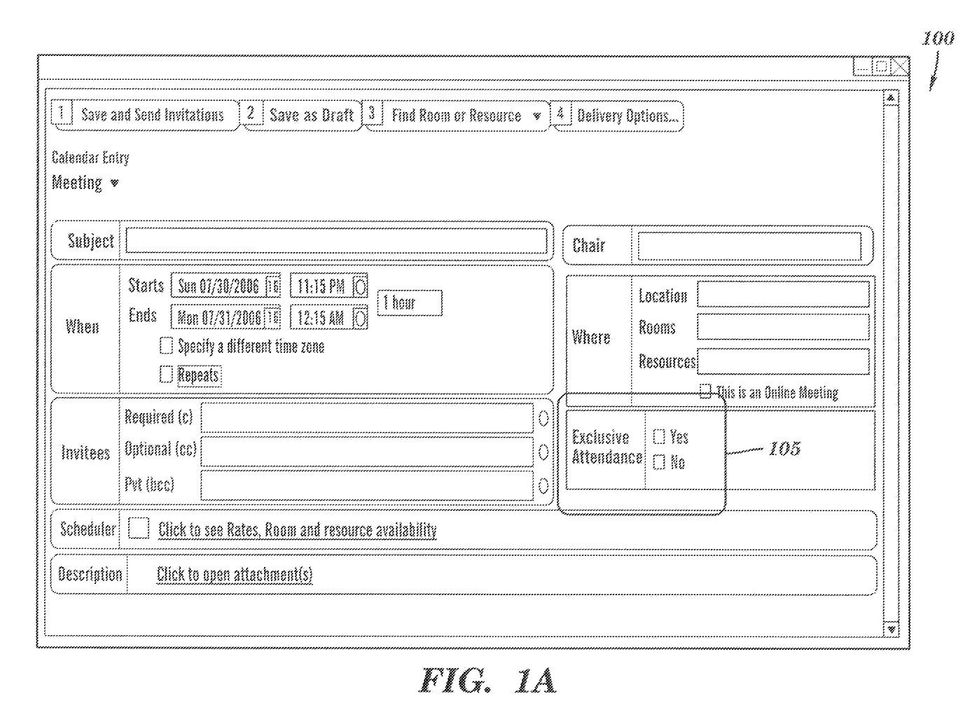

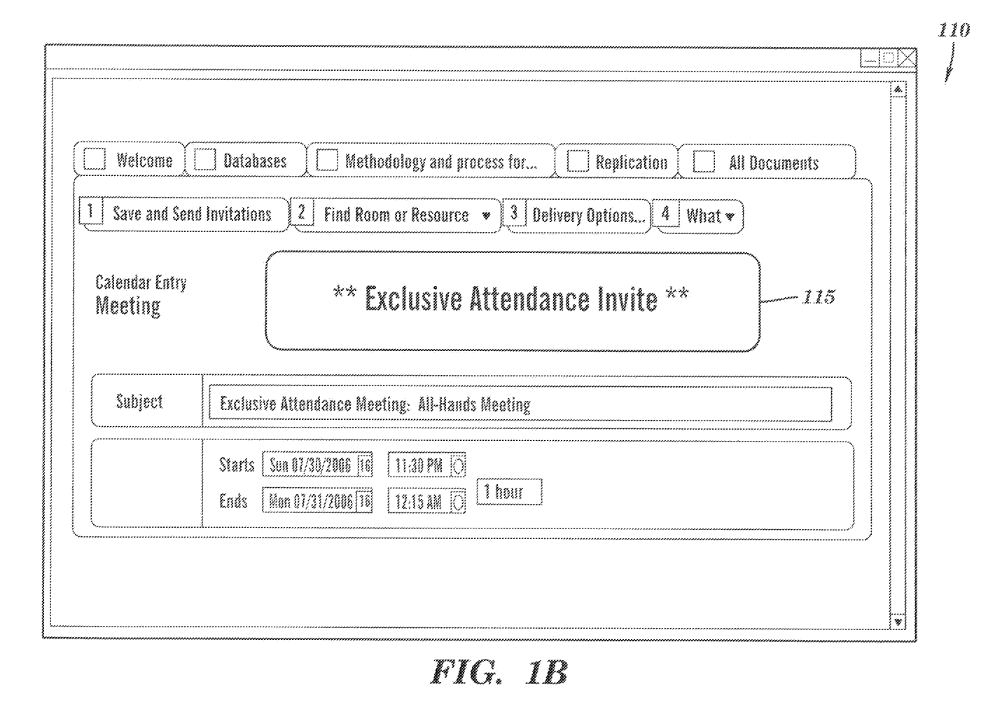

Turning now to the drawings in greater detail, it will be seen that in FIG. 1A there is a screenshot 100 of a meeting invitation with expressly showing that the meeting invite is in regard to an exclusive meeting event. Exemplary embodiments of the present invention comprise the implementation a calendar event scheduling application locally at a plurality of networked computing. The calendar event scheduling application further comprises calendar invitation GUI, wherein the GUI is enhanced to display a notification 105 that participation in a particular meeting can be accepted under the categories of exclusive attendance or non-exclusive attendance. The default preference for all meetings that are initiated is that the attendee be designated as having a preference for exclusive attendance at a meeting. FIG. 1B shows a screenshot of a meeting event invitation that expressly display the message 115 that the invitation pertains to an exclusive attendance invitation.

A computing system suppression functionality is provided as a feature of the calendar event scheduling application. By accepting an invitation to an exclusively attend a meeting an invitee also accepts any terms that prescribed for the meeting. These terms can include the suppression of local application interactions and incoming communications within the invitees computing system. As such, the computing system suppression feature is initiated to effectively suspend the local execution of non-calendar event scheduling applications within the computing system. Further, all incoming and outgoing communication activity within the computing system is suspended when the computing system suppression feature is initiated. The computing system suppression functionality is integrated to work as an operational function of the exclusive meeting attendance selection as 105 that is displayed at the GUI 100.

Within further exemplary embodiments, a selection window is presented at the GUI is presented which lists which electronic communication methods and local applications are to be suppressed during the time period of a respective meeting. The default is for all methods to be listed as suppressed. When the meeting invite is received, the list of interface points suppressed are listed, or a message reporting that all interfaces suppressed is displayed to the message receiver. Upon selecting the category of attendance (in addition to the system interface suppression preferences in further exemplary embodiments) a meeting invitee accepts the meeting, and thereafter the meeting will be notated at a GUI calendar as currently scheduled. Thereafter, upon a meeting occurring at a scheduled time, the meeting invitation specifications will take effect (suppressing incoming communications and suppressing local application activity).

The calendar event scheduling application detects an upcoming scheduled meeting event and displays a message notifying a system user of the meeting in addition to the classification of the meeting event as an exclusively accepted meeting event. A system user can also be notified that current application work should be saved off and that the user should be prepared to suspend local application interfaces. Upon the initiation of the meeting, the calendar event scheduling application suspends communication exchanges within the computing system (e.g., instant messaging operations) and local application execution.

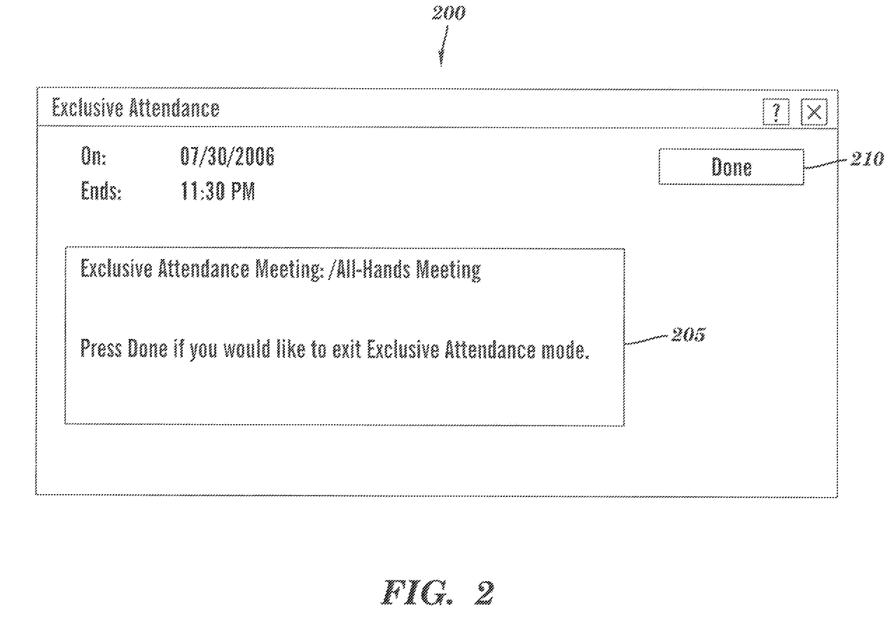

FIG. 2 shows a screenshot of a meeting attendance message 200. Upon the initiation of the meeting event a new display appears on the screen alerting the user that suppression is now enabled 205. At this point, the local system will not accept any new keystroke interfaces for any unapproved applications. All input keystrokes at a computing system are intercepted. Further, any local system activities that are not keystroke initiated (e.g., incoming chat requests that cause a new window to appear) are also disabled and unavailable. Effectively, the system has put into a sleep mode since it does not accepting or allowing distracting activities. A system user can cancel this support at any point in a meeting by selecting a “done” button 210 displayed at the GUI 200. Any keystroke entered into the system other than selecting the “done” option 210 is discarded. While the GUI display 200 is posted, a time counter is displayed, which lists the remaining time for this meeting. If a system user selects this option, their name and time of meeting exit are delivered to the meeting originator of the meeting event. Once a user has exited the exclusive attendance mode, they are given the option to re-enter the mode, as they resume in the meeting. This meeting re-entry is logged and reported to the meeting initiator.

At the conclusion of a meeting event local system control is returned to the invited user. This restore of control occurs at the end of the meeting. As a result, keyboard interception is restored, communication channels are opened, and a status box appears on the computing systems screen informing the user that the exclusive event attendance mode has been terminated.

Within yet further exemplary embodiments of the present invention the initiator of a meeting specifically dictate what forms of communication may be allowed within a meeting event. (e.g., allow email, not allow instant messaging). Further, the meeting initiator can have the capability to re-enable attendee application interactions in order to have all or a select few of the meeting event attendees utilize applications on their local systems. The meeting initiator also can turn off the local application interactions again at a later point in the meeting.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the suppressing computing system activities during a scheduled event, the method comprising:
creating an invitation for an event at an event scheduling application executing at a primary computing system, the event invitation comprising an exclusive attendance event acceptance category and a non-exclusive attendance event acceptance category;
transmitting the event invitation from the event scheduling application executing at the primary computing system to at least one secondary computing system;
receiving the event invitation at an event scheduling application that is executing at the secondary computing system;
accepting the event invitation at the event scheduling application executing at the secondary computing system, where in the instance that the event is accepted as an exclusive attendance event then communication and non-event scheduling application executing activities within the secondary computing system will be suspended upon the initiation of the event, and in the instance that the event is accepted as a non-exclusive attendance event a message is generated and delivered to the primary event scheduling application reporting that the event has been accepted as a non-exclusive event;
generating an event reminder at the event scheduling application executing at the secondary computing system;
initiating the event, wherein upon the initiation of the event the communication and non-event scheduling application executing activities within the secondary computing system are suspended;
displaying a GUI window at the secondary computing system at the initiation of the event, where in the instance that the event is accepted as an exclusive attendance event then the operator of the secondary computing system is presented with the option of disabling the system suspension of the secondary computing system and exiting the event; and
restoring the communication and nonevent scheduling application executing activities within the secondary computing system upon the completion of the event.

2. The method of claim 1, where in the even that a secondary computing system user disables the system suspension of the secondary computing system a message is generated at the event scheduling application of the secondary computing system and delivered to the event scheduling application of the primary computing system reporting the secondary computing system's user exiting the event.

3. The method of claim 1, wherein the secondary computing system communication and non-event scheduling application executing activities can be restored via the primary event scheduling application.

4. A computer program product that includes a computer readable medium useable by a processor, the medium having stored thereon a sequence of instructions which, when executed by the processor, causes the processor to suppress the computing system activities within a computing system by:
receiving an event invitation, the event invitation comprising an exclusive attendance event acceptance category and a non-exclusive attendance event acceptance category;
accepting the event invitation, where in the instance that the event is accepted as an exclusive attendance event then communication and non-event scheduling application executing activities will be suspended upon the initiation of the event, and in the instance that the event is accepted as a non-exclusive attendance event a message is generated and delivered to a primary event scheduling application reporting that the event has been accepted as a non-exclusive event;
generating an event reminder;
initiating the event, wherein upon the initiation of the event the communication and non-event scheduling application executing activities are suspended;
displaying a GUI window at the initiation of the event, where in the instance that the event is accepted as an exclusive attendance event then the GUI window presents the option of disabling the suspension of the communication and non-event scheduling application executing activities and exiting the event; and
restoring the communication and non-event scheduling application executing activities upon the completion of the event.

5. The computer program product of claim 4, where in the event that the system suspension of the communication and non-event scheduling application executing activities is disabled a message is generated and delivered to the event scheduling application of the primary event scheduling application reporting the disabling of the suspension of the communication and non-event scheduling application executing activities.

6. The computer program product of claim 4, wherein the communication and non-event scheduling application executing activities can be restored via the primary event scheduling application.
